(19) United States
(12) Patent Application Publication
(10) Pub. No.: US 2017/0146180 A1
(43) Pub. Date: May 25, 2017

(54) LEVELLING DEVICE WITH FROM BELOW MOUNTED SLEEVE AND USE

(71) Applicant: NGI A/S, Nørresundby (DK)

(72) Inventor: Lars Von LILLIENSKJOLD, Hjørring (DK)

(73) Assignee: NGI A/S, Norresundby (DK)

(21) Appl. No.: 15/310,089

(22) PCT Filed: Apr. 9, 2015
(86) PCT No.: PCT/DK2015/050085

§ 371 Date: Nov. 9, 2016

(30) Foreign Application Priority Data
May 27, 2014 (DK) PA 2014 00290

(51) Int. Cl. F16M 7/00; A47B 91/02

(52) U.S. Cl. CPC F16M 7/00; A47B 91/022; F16M 2200/08

(57) ABSTRACT

The invention relates to a levelling device, which includes a top part and a lower part where there in the top part is included a spindle, which includes a thread and an external cylindrical surface and a sleeve with at least one internal stop surface and that the spindle includes at least one stop surface. According to an exemplary aspect of the invention, it is achieved that it is possible to manufacture a levelling device where the sleeve, as a result of the stop surface on the sleeve and the stop surface on the spindle, cannot be screwed so high up that parts of the thread on the spindle are exposed.

### CROSS-REFERENCE TO RELATED APPLICATIONS

This application is a U.S. national stage of International Appl. No. PCT/DK2015/050085 filed 9 Apr. 2015, which claimed priority to Danish Appl. No. PA 2014 00290 filed 27 May 2014, which applications are all incorporated herein by reference in their entireties.

### TECHNICAL FIELD

The invention relates to a levelling device for levelling and support of items, such as machines, which levelling device includes a top part for fastening in an item such as a machine and a lower part for contact against a base such as a floor and where there in the top part is included a spindle, which includes a thread, a lower end surface at the lower part and an external cylindrical surface between the thread and the lower end surface and a center axis and a sleeve, which includes a first end surface closest to the lower part and another end surface in the opposite end of the sleeve and an internal thread in an area at the other end surface and designed to go in mesh with the thread on the spindle and an internal cylindrical surface between the internal thread and the first end surface with a larger circumference than the external circumference on the spindle's thread.

The invention also relates to the use of the levelling device.

### BACKGROUND

On existing levelling devices for use in locations with high demands for hygiene and with spindles above a certain diameter, today there is typically used a sleeve, which is mounted from above around the spindle, to shield the thread on the spindle.

Sleeve in this connection technically describes a thread cover.

The sleeve is mounted from the top, since the sleeve is typically mounted following the top part being connected with the lower part.

The sleeve could also be mounted from below, if it occurs before the top part is connected with the lower part.

The thread on the spindle must be covered with a shielding, since cleaning a thread with small edges and sharp corners is very difficult. It is also a requirement that the thread on the spindle is shielded in connection with achieving authority approvals of the levelling device, including a USDA approval.

This sleeve seals with a lower sealing item lowermost towards the spindle below the spindle's thread and uppermost with an upper sealing item towards the lower side of an item, such as a machine, which is to be supported by the levelling device, such that filth and bacteria can not get into the thread on the spindle.

It will be described in a mounting instruction that you may not screw the sleeve such high up that the lowermost part of the thread on the spindle becomes visible.

There are, however, certain drawbacks of the known technology, including that it is possible to screw the sleeve so far up that the lowermost sealing item is led with the sleeve up over the thread on the spindle and thus the thread on the spindle is partially exposed and dirt and bacteria can enter into the thread and also up under the sleeve, since the lower sealing item can not seal against the thread itself on the spindle. This occurs despite the fact that it is described in the installation instruction that the sleeve must not be screwed so high up. In addition, it is expected that the authority approvals of the levelling device, including at USDA, will require that neither the whole thread or parts of the thread on the spindle can be exposed at a potential faulty use.

### SUMMARY OF THE INVENTION

It is therefore an object of the invention to show a levelling device without the above-mentioned drawbacks or at least provide a useful alternative.

The object of the invention is achieved by a levelling device for levelling and support of items, such as machines, which levelling device includes a top part for fastening in an item such as a machine and a lower part for contact against a base such as a floor and where there in the top part is included a spindle, which includes a thread, a lower end surface at the lower part, an external cylindrical surface between the thread and the lower end surface and a center axis and where the spindle passes through a sleeve, which includes a lower end surface above the lower part and an upper end surface in the opposite end of the sleeve and an internal thread at the upper end surface which meshes with the thread on the spindle, and the sleeve further having an internal cylindrical surface between the internal thread and the lower end surface with a larger internal circumference than the external circumference on the spindle's thread, which is characterized in that the sleeve includes at least one internal stop surface, proceeding preferably perpendicular on the center axis and placed between the internal thread and first end surface on the sleeve, which internal stop surface/surfaces are limited by the internal cylindrical surface and another surface, which other surface is placed between the spindle's external cylindrical surface and the outer circumference on the spindle's thread and by the spindle including at least one stop surface, preferably perpendicular with the center axis and placed between the thread on the spindle and the lower end surface, which stop surface/surfaces are limited by the external cylindrical surface and the outer circumference on the spindle's thread.

In this way, it thus becomes possible to produce a levelling device, where the sleeve can not be screwed so high up that the whole or parts of the lowermost of the spindle's thread is exposed. In addition, it can be ensured that there will always be thread in the top of the spindle to fix in the item, which is to be supported. The levelling device, which with its other construction details can be used in locations with high hygienic requirements, can thus in the future also be approved by the USDA, 3A and EHEDG if it is implemented as requirement by the relevant authorities that the spindle's thread must not be exposed by screwing the sleeve too high up. By designing stop surfaces as stated on both the spindle as well as the sleeve, there is provided an upper stop for the movement of the sleeve, thereby ensuring that the whole or parts of the thread on the spindle can not be exposed by an error.

Further appropriate embodiments for the levelling device are stated herein.

By an additional aspect of the invention, the levelling device includes that the other surface on the sleeve is a cylindrical surface. It is hereby achieved that the other surface can be created by a simple turning process

By an additional aspect of the invention, the levelling device includes that the stop surface/surfaces on the sleeve are perpendicular on the spindle's center axis. It is hereby achieved that the reaction forces, when the stop surface hits the stop surface on the spindle, can be transferred without displacement forces.

By an additional aspect of the invention, the levelling device includes that the stop surface/surfaces on the sleeve consist of a single stop surface. It is hereby achieved that the stop surface can be created by a simple turning process and that the surface gets maximum area to transfer the reaction forces, when the stop surface hits the stop surface on the spindle.

By an additional aspect of the invention, the levelling device includes that the stop surface/surfaces on the sleeve consists of the internal surfaces on a ledge in the area where the first end surface on the sleeve is found.

It is hereby achieved that the stop surface can be placed so close to the first end surface on the sleeve as possible to make the distance between this stop surface and the stop surface on the spindle, when the screwing on of the sleeve is started, as large as possible and thereby that the sleeve can be screwed as far up as possible

By an additional aspect of the invention, the levelling device includes that the ledge is designed to support a lower sealing item, which lower sealing item is designed to seal between the sleeve and the spindle's cylindrical surface.

It is hereby achieved that the ledge can be used for two purposes, to support a sealing item and provide a stop surface and thereby that you save material and thereby weight in the sleeve.

By an additional aspect of the invention, the levelling device includes that the stop surface/surfaces on the spindle are perpendicular on the spindle's center axis.

It is hereby achieved that the reaction forces, when the stop surface hits the stop surface on the sleeve can be transferred without transverse forces.

By an additional aspect of the invention, the levelling device includes that the stop surface/surfaces on the spindle consist of a single stop surface It is hereby achieved that the stop surface can be created by a simple turning process and that the surface gets maximum area to transfer the reaction forces when the stop surface hits the stop surface on the sleeve.

By an additional aspect of the invention, the levelling device includes that the cylindrical surface on the spindle defines the outermost diameter on the spindle in the whole area between the spindle's thread and the lower end surface on the spindle.

It is hereby achieved that the sleeve can be led up around the spindle from below and that the sealing item can seal against the cylindrical surface without first having to pass a larger diameter.

As mentioned, the invention also relates to the use of the above levelling device in locations with high requirements for hygiene such as locations for processing foodstuffs or manufacturing of medicine.

### BRIEF DESCRIPTION OF THE DRAWINGS

The invention will now be explained more fully with reference to the drawings, on which:

FIG. 1 shows an assembled top part according to the invention

FIG. 2 shows a sectional view through the top part along the line A-A shown in FIG. 1

FIG. 3 shows an exploded top part according to the invention

FIG. 4 shows a sectional view through the top part along the line B-B shown in FIG. 2.

FIG. 5 shows an assembled levelling device

### DETAILED DESCRIPTION OF THE INVENTION

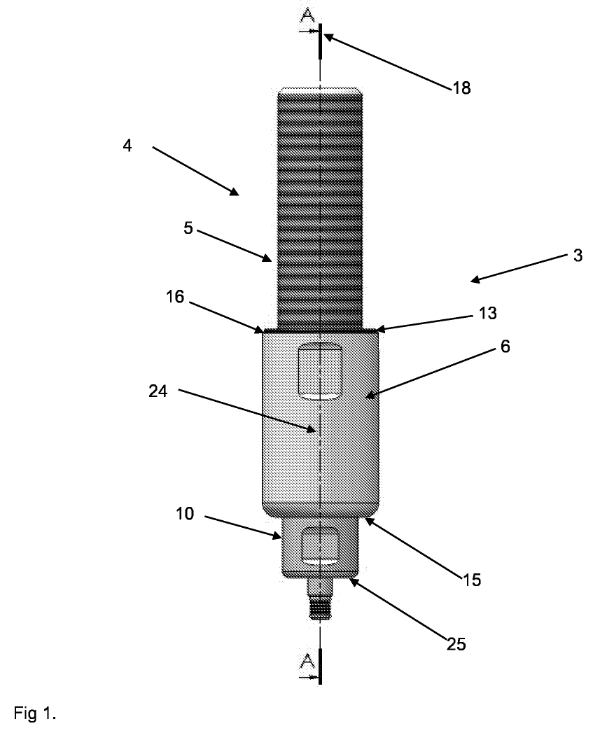

In FIG. 1 is with (3) indicated shown a top part, which includes a spindle (4), with a thread (5) up the uppermost part of the spindle (4) and a cylindrical surface (10) on the lowermost part of the spindle (4), the top part (3) also includes a mostly cylindrical sleeve (6).

The thread (5) on the spindle has an outer circumference, which is larger than the circumference on the spindle's (4) cylindrical surface (10)

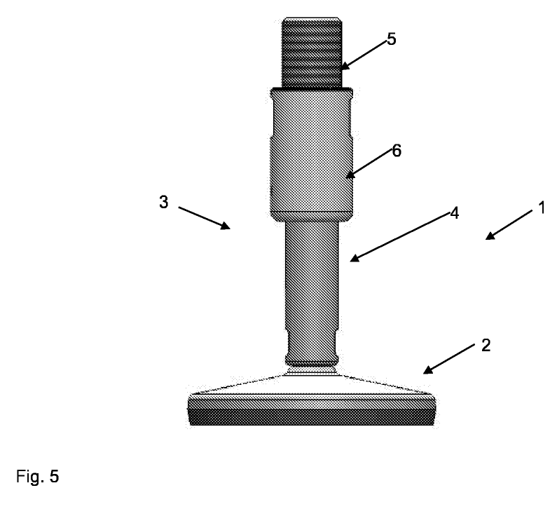

With (15) indicated is shown a surface, which consists a first end surface (15) on the sleeve (6). The fists end surface (15) is in an assembled levelling device (1) placed closest to a lower part (2), where the assembled levelling device (1) and the lower part (2) can be seen on FIG. 5.

With (16) indicated is shown another surface, which consists another end surface (16) on the sleeve (6) placed in the opposite end of the first end surface (15) on the sleeve (6).

With (13) indicated is shown an upper sealing item, which is mounted on the sleeve (6) at the sleeve's (6) other end surface (16). This upper sealing item (13) is designed to seal between the sleeve (6) and the supported item and thereby ensures that filth and bacteria can not get into the spindle's (4) thread (5) in this area.

With (25) indicated is shown a lower end surface on the spindle (4), which lower end surface (25) in an assembled levelling device (1) is placed closest to the lower part (2).

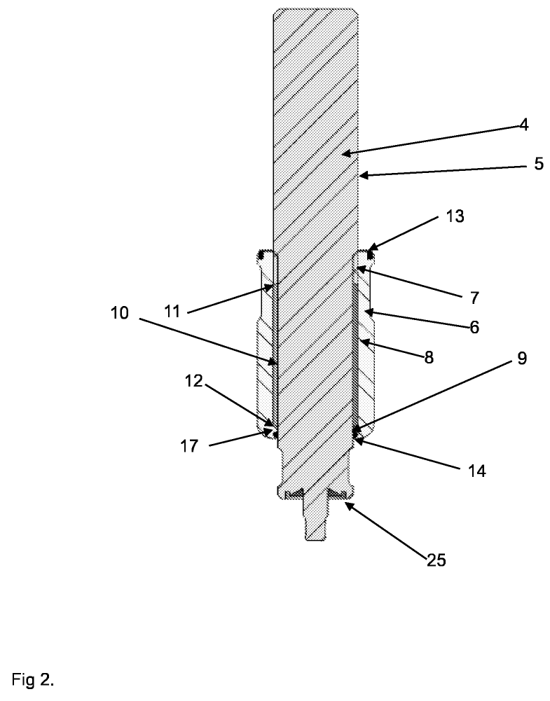

With (18) indicated is shown a sectional marking, where the sectional view is shown in FIG. 2.

With (24) indicated is shown a center axis in the spindle (4)

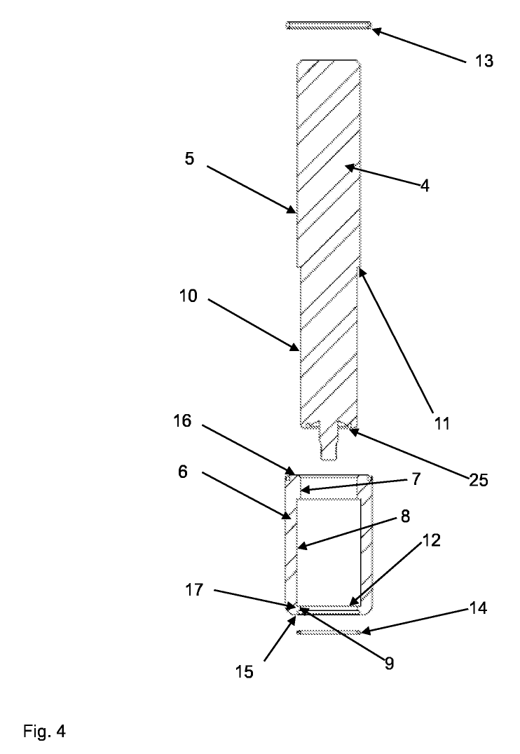

In FIGS. 2 and 4 is with (7) indicated shown an internal thread in the sleeve (6), which is designed to go in mesh with the thread (5) on the spindle (4).

The thread (7) on the sleeve (6) is placed at the sleeve's (6) other surface (16) and consists a part of the internal geometry in the sleeve (6)

In FIGS. 1 to 4 is with (10) indicated shown a cylindrical surface on the spindle (4), which is placed between the spindle's (4) thread (5) and lower end surface (25). In a preferred embodiment, the cylindrical surface (10) is smooth by which there is understood that the surface is without thread and suited for forming contact for a sealing item (14).

The circumference of this cylindrical surface (10) on the spindle (4) is smaller than the outer circumference on the spindle's (4) thread (5). This difference in diameters is used to provide a stop surface (11), which is thus limited by the spindle's (4) cylindrical surface (10) and external circumference on the spindle's (4) thread (5).

The cylindrical surface (10) defines the outer diameter on the spindle (4) in the whole area from the spindle's (4) thread (5) and to the lower end surface (25) on the spindle (4).

On the lower part of the cylindrical surface (10) there are two parallel plane surfaces on each side of the center axis (24). The surfaces are used for contact for a screw wrench such that it is possible to turn the spindle or to hold it fixed.

15

In FIGS. 2, 3 and 4 is with (14) shown a lower sealing item, which is mounted on the sleeve (6) in the area at the first end surface (15). This lower sealing item (14) seals between the sleeve (6) and the spindle's (4) cylindrical surface (10) below the thread (5) on the spindle (4) and thereby ensures that filth and bacteria can not get into the spindle's (4) thread (5) in this area.

In FIGS. 2 and 4 is with (8) shown an internal cylindrical surface on the sleeve (6). This cylindrical surface (8) has a circumference which is larger than the outer circumference of the spindle's (4) thread (5), such that the cylindrical surface (8) can be led up around the thread (5) on the spindle (4) when the sleeve (6) with the internal thread (7) is screwed up on the spindle's thread (5). The cylindrical surface (8) is placed between the thread (7) on the sleeve (6) and the first end surface (15). The surface (8) is in a preferred embodiment cylindrical, but can in another embodiment have a non-cylindrical cross-section in a plane perpendicular to the center axis (24), including polygonal.

In FIGS. 2 and 4 is with (11) indicated shown a stop surface on the spindle (4), which stop surface (11) proceeds perpendicular to the center axis (24) and is limited inwards by the spindle's (4) cylindrical surface (10) and outwards by the outer circumference on the spindle's (4) thread (5). The surface (11) is in a preferred embodiment placed where the thread (5) and the cylindrical surface (10) on the spindle (4) meet, but can also be placed further down in direction towards the lower end surface (25) on the spindle (4). The surface (11) is here shown perpendicular on the center axis (24) but can also have other designs, including to be inclined in relation to the center axis (24) and is thus not limited to the plane surface shown here.

In FIGS. 2 and 4, is with (9) indicated shown another internal surface on the sleeve (6) which is placed between the spindle's (4) external cylindrical surface (10) and the outer circumference of the spindle's (4) thread (5). The surface (9) is in a preferred embodiment cylindrical, but can in another embodiment have a non-cylindrical cross-section in a plane perpendicular to the center axis (24), including polygonal.

In FIGS. 2 and 4 is with (12) indicated shown a stop surface on the sleeve (6), which is limited by the internal cylindrical surface (8) and the other surface (9). The stop surface (12) is shown here as a disc-shaped surface on the sleeve (6), between the two surfaces (8, 9). The stop surface (12) is in a preferred embodiment plane and proceeding perpendicular to the spindle's (4) center axis (24), but is not limited to this orientation and shape, including it can in another embodiment be inclined in relation to the center axis (24), or consist of several separate surfaces. The stop surface (12) on the sleeve (6) is also in a preferred embodiment placed so close to the first end surface (15) on the sleeve (6) as possible, such that the distance between this stop surface (12) and the spindle's (4) stop surface (11) when screwing on of the sleeve (6) is started, is as large as possible, such that the sleeve (6) can be screwed as far as possible up over the thread (5) on the spindle (4).

In FIGS. 2 and 4 is with (17) indicated shown a ledge on the sleeve (6) which is limited by the internal cylindrical surface (8) and the other internal surface (9) on the sleeve (6). This ledge has an internal side, proceeding preferably perpendicular to the spindle's (4) center axis (24), which consists the stop surface (12). This ledge (17) consists, in a preferred embodiment, also support for the lower sealing item (14). In another embodiment, this ledge (17) on the sleeve (6), which with its internal side consists the stop surface (12) can be placed in a larger distance from the first end surface (15) and thereby, the sleeve's (6) possibility of upwards movement will be reduced, since the distance between the stop surface (12) on the sleeve (6) and the stop surface (11) on the spindle (4) is reduced. The support of the lower sealing item (14) must thus consist of another element on the sleeve (6).

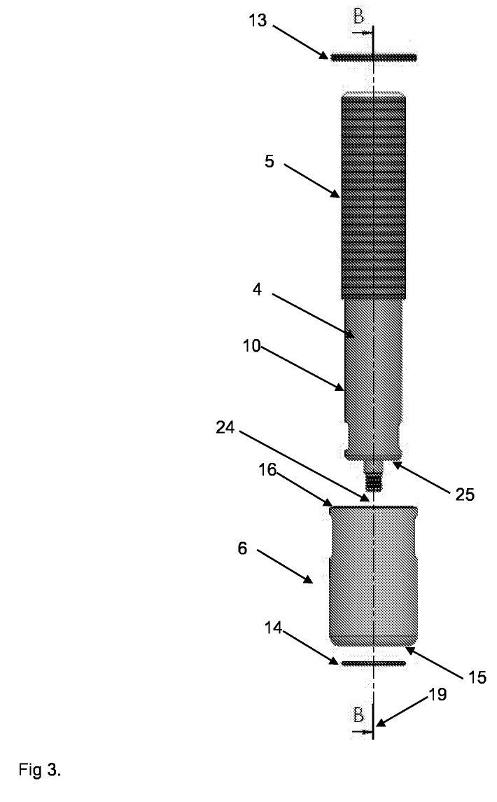

In FIG. 3 is with (19) indicated shown a sectional marking, where the sectional view is shown in FIG. 4.

In FIG. 5 is with (1) indicated shown an assembled levelling device, which includes a top part (3) and a lower part (2). On the figure, the sleeve (6) is turned a distance up on the spindle's (4) thread (5)

In a levelling device (1) according to the invention, it is not possible to expose the whole or parts of the lowermost of the spindle's (4) thread (5) by an error when the sleeve (6) is screwed up in order to seal against the item, which is to be supported, since there, by adding stop surfaces as stated on both the spindle and on the sleeve (6), is provided an upper stop for the sleeve's (6) movement. Thereby, the expected future requirements from the authorities can be met and the authority approvals, including from USDA, are achieved.

The sleeve (6) must be mounted from below before the top part (3) is assembled with the lower part (2)

By adjusting the length of the sleeve (6) in relation to the spindle's (4) thread (5), such that the spindle's (4) thread (5) is longer than the sleeve (6), it can be ensured that there is always sufficient free thread (5) at the top of the spindle (4) to fix an item, such as a machine, even though the sleeve (6) is screwed to the top.

In another embodiment of the sleeve (6), the thread (7) on the sleeve (6) can continue to the stop surface (12) such that the internal cylindrical surface (8) does not exist.

It is a part of the invention that the described levelling device (1) is used in locations with high requirements for hygiene such as locations for processing foodstuffs or manufacturing of medicine.

1-9. (canceled)

10. A levelling device for levelling and support of items, comprising:
a top part for fastening in an item; and
and a lower part for contact against a base;
wherein the top part comprises a spindle having a thread, a lower end surface at the lower part, an external cylindrical surface between the thread and the lower end surface and a center axis;
wherein the spindle passes through a sleeve having a lower end surface above the lower part, an upper end surface in the opposite end of the sleeve and an internal thread at the upper end surface which meshes with the thread on the spindle;
wherein the sleeve further comprises an internal cylindrical surface between the internal thread and the lower end surface with a larger internal circumference than the external circumference on the thread of the spindle;
wherein the sleeve below the internal thread includes at least one radially inwardly extending stop surface, extending from the internal cylindrical surface and at least past the outer circumference of the thread of the spindle, when the spindle extends through the sleeve, and
wherein the spindle between the thread and the lower end surface includes at least one radially extending stop surface extending between the external cylindrical surface and the outer circumference on the thread of the spindle to allow the radially inwardly extending stop surface to move along the external cylindrical surface to the radially extending stop surface when the sleeve is turned.

11. The levelling device according to claim 10, wherein the at least one radially inwardly extending stop surface on the sleeve are perpendicular on the center axis of the spindle.

12. The levelling device according to claim 10, wherein the at least one radially inwardly extending stop surface on the sleeve consists of a single radially inwardly extending stop surface.

13. The levelling device according to claim 10, wherein the radially inwardly extending stop surface on the sleeve consists of the internal surfaces on a ledge in the area where the first end surface on the sleeve is found.

14. The levelling device according to claim 13, wherein the ledge is designed to support a lower sealing item, which lower sealing item is designed to seal between the sleeve and the cylindrical surfaces of the spindle.

15. The levelling device according to claim 10, wherein the at least one radially extending stop surface on the spindle are perpendicular on the center axis of the spindle.

16. The levelling device according to claim 10, wherein at least one radially extending stop surface on the spindle consist of a single radially extending stop surface.

17. The levelling device according to claim 10, wherein the cylindrical surface on the spindle defines the outer diameter on the spindle in the whole area between the thread of the spindle and the lower end surface on the spindle.

18. Use of levelling device according to claim 10 in locations with high requirements for hygiene such as locations for processing foodstuffs or manufacturing of medicine.
